(19) United States
(12) Patent Application Publication
(10) Pub. No.: US 2025/0030816 A1
(43) Pub. Date: Jan. 23, 2025

(54) IMMERSIVE VIDEO CONFERENCE SYSTEM

(71) Applicant: Microsoft Technology Licensing, LLC, Redmond, WA (US)

(72) Inventors: Jiaolong YANG, Beijing (CN); Yizhong Zhang, Beijing (CN); Xin TONG, Beijing (CN); Baining GUO, Redmond, WA (US)

(21) Appl. No.: 18/710,438

(22) PCT Filed: Nov. 10, 2022
(86) PCT No.: PCT/US2022/049472

§ 371 Date: May 15, 2024

(30) Foreign Application Priority Data
Dec. 13, 2021 (CN) 202111522154.3

(51) Int. Cl. H04N 7/15; G06T 5/50; G06T 7/55; G06V 40/16

(52) U.S. Cl. CPC H04N 7/157; G06T 5/50; G06T 7/55; G06V 40/168; G06T 2207/20084; G06T 2207/20221

(57) ABSTRACT

According to implementations of the subject matter described herein, there is provided a solution for an immersive video conference. In the solution, a conference mode for the video conference is determined at first, the conference mode indicating a layout of a virtual conference space for the video conference, and viewpoint information associated with the second participant in the video conference is determined based on the layout. Furthermore, a first view of the first participant is determined based on the viewpoint information and then sent to a conference device associated with the second participant to display a conference image to the second participant. Thereby, on the one hand, it is possible to enable the video conference participants to obtain a more authentic and immersive video conference experience, and on the other hand, to obtain a desired virtual conference space layout according to needs more flexibly.

### BACKGROUND

In recent years, due to the influence from factors in many aspects, remote video conferences are gradually applied to many aspects such as people's work and recreation. Remote video conferences can effectively help participants to overcome limitations such as distance and achieve remote collaboration.

However, as compared with a face-to-face meeting, it is very difficult for participants in the video conference to feel visual information such as eye contact and perform natural interaction (including head turning, head turning and attention transfer in multi-participant meeting, private conversation, and sharing of documents etc.) so that it is difficult for the video conference to provide efficient communication as in the face-to-face meeting.

### SUMMARY

According to implementations of the subject matter described herein, there is provided a solution for an immersive video conference. In the solution, a conference mode for the video conference is determined at first, the conference mode indicating a layout of a virtual conference space for the video conference. Furthermore, viewpoint information associated with the second participant is determined based on the layout, the viewpoint information indicating a virtual viewpoint of the second participant viewing the first participant in the video conference. Furthermore, a first view of the first participant is determined based on the viewpoint information, and the first view is sent to a conference device associated with the second participant to display a conference image to the second participant, the conference image being generated based on the first view. Thereby, on the one hand, it is possible to enable the video conference participants to obtain a more authentic and immersive video conference experience, and on the other hand, to obtain a desired virtual conference space layout according to needs more flexibly.

The Summary is to introduce a selection of concepts in a simplified form that are further described below in the Detailed Description. This Summary is not intended to identify key features or essential features of the subject matter described herein, nor is it intended to be used to limit the scope of the subject matter described herein.

### BRIEF DESCRIPTION OF THE DRAWINGS

FIG. 1 illustrates a schematic diagram of an example conference system arrangement according to some implementations of the subject matter described herein;

FIG. 2A and FIG. 2B illustrate schematic diagrams of a conference mode according to some implementations of the subject matter described herein;

FIG. 3A and FIG. 3B illustrate schematic diagrams of a conference mode according to further implementations of the subject matter described herein;

FIG. 4A and FIG. 4B illustrate schematic diagrams of a conference mode according to further implementations of the subject matter described herein;

FIG. 5 illustrates a schematic block diagram of an example conference system according to some implementations of the subject matter described herein;

FIG. 6 illustrates a schematic diagram of determining viewpoint information according to some implementations of the subject matter described herein;

FIG. 7 illustrates a schematic diagram of a view generation module according to some implementations of the subject matter described herein;

FIG. 8 illustrates a schematic diagram of a depth prediction module according to some implementations of the subject matter described herein;

FIG. 9 illustrates a schematic diagram of a view rendering module according to some implementations of the subject matter described herein;

FIG. 10 illustrates a flowchart of an example method for a video conference according to some implementations of the subject matter described herein;

FIG. 11 illustrates a flowchart of an example method for generating a view according to some implementations of the subject matter described herein; and

FIG. 12 illustrates a block diagram of an example computing device according to some implementations of the subject matter described herein.

Throughout the drawings, the same or similar reference symbols refer to the same or similar elements.

### DETAILED DESCRIPTION OF EMBODIMENTS

The subject matter described herein will not be described with reference to several example implementations. It would be appreciated that description of those implementations is merely for the purpose of enabling those skilled in the art to better understand and further implement the subject matter described herein and is not intended for limiting the scope disclosed herein in any manner.

As used herein, the term “includes” and its variants are to be read as open-ended terms that mean “includes, but is not limited to.” The term “based on” is to be read as “based at least in part on.” The terms “an implementation” and “one implementation” are to be read as “at least one implementation.” The term “another implementation” is to be read as “at least one other implementation.” The term “first,” “second” or the like can represent different or the same objects. Other definitions, either explicit or implicit, may be included below.

As discussed above, as compared with face-to-face meeting, it is very difficult for participants in the video conference to feel vision information such as eye contact so that it is difficult for the video conference to provide efficient communication as in the face-to-face meeting.

According to an implementation of the subject matter described herein, a solution for a video conference is provided. In this solution, a conference mode of the video conference is determined at first, and the conference mode may indicate an arrangement of a virtual conference space of the video conference. Furthermore, viewpoint information associated with a second participant in the video conference may be determined based on the arrangement, the viewpoint information being used to indicate a virtual viewpoint of the second participant upon viewing the first participant in the video conference. Furthermore, a first view of the first participant may be determined based on the viewpoint information, and the first view may be sent to a conference device associated with the second participant, to display a conference image generated based on the first view to the second participant.

The embodiments of the subject matter described herein may improve the flexibility of the conference system by flexibly constructing the virtual conference space according to the conference mode. In addition, by generating viewpoint-based views based on viewpoint information, embodiments of the subject matter described herein may also enable video conference participants to obtain a more authentic video conference experience.

The basic principles and several example implementations of the subject matter described herein are explained below with reference to the accompanying drawings.

### Example Arrangement

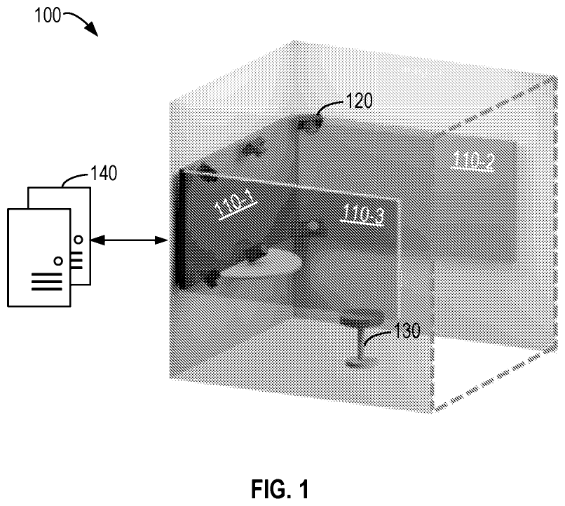

FIG. 1 illustrates an example conference system arrangement 100 according to some implementations of the subject matter described herein. As shown in FIG. 1, the arrangement 100 (also referred to as a conference unit) may for example include a cubic physical conference space, which for example may also be referred to as a Cubicle. As will be described in detail below, such a physical conference space may be dynamically constructed as a virtual conference space for a video conference according to the arrangement indicated by the conference mode, thereby improving the flexibility of the conferencing system.

As shown in FIG. 1, the arrangement 100 may further include display devices 110-1, 110-2 and 110-3 (referred to individually or collectively as the display devices 110). In the example arrangement 100 of FIG. 1, the display device 110 may include three separate display screens disposed on three walls of the physical conference space, and may be configured to provide immersive conference images to participants seated in chairs 130. In some implementations, the display device 110 may also be disposed on one wall or two walls of the physical conference space, for example.

In some implementations, the display device 110 may also include an integrally-formed flexible screen (e.g., annular screen). The flexible screen may, for example, have a viewing angle of 180 degrees to provide immersive conference images to the participants.

In some implementations, the display device 110 may also provide participants with immersive conference images through other suitable image presentation techniques. Exemplarily, the display device 110 may include a projection device for providing immersive images to the participants. The projection device may for example project conference images on a wall of the physical conference space.

As will be described in detail below, immersive conference images may include views of other conference participants in the video conference. In some implementations, the display device 110 may have a proper size, or the immersive images may be made have proper sizes so that the views of other conference participants in the immersive images as viewed by the participant have a real proportion, thereby improving the sense of reality of the conference system.

Additionally, immersive conference images may further include a virtual background to enhance the sense of reality of the video conference. Additionally, the immersive conference images may, for example, further include an operable image region, which may, for example, provide a function such as an electronic whiteboard to provide a corresponding response in response to a proper participant's operation in the video conference.

As shown in FIG. 1, the arrangement 100 may further include a set of image capture devices 120.

In some implementations, as shown in FIG. 1, to improve the quality of the generated views of the participants, the set of image capture devices 120 may include a plurality of cameras which capture images of the participants from different directions. As shown in FIG. 1, the set of image capture devices 120 for example may be disposed on a wall in the physical conference space.

In some implementations, the image capture device 120 for example may include a depth camera to capture image data and corresponding depth data of the participants. Alternatively, the image capture device 120 may also include a common RGB camera, and may determine the corresponding depth information by a technique such as binocular vision. In some implementations, all cameras included in image capture devices 120 may be configured to be capable of capturing images synchronously.

In some implementations, other corresponding components may also be set in the arrangement 100 according to the needs of the conference mode, for example, a semicircular table top for a round table conference mode, an L-shaped corner table top for a side-by-side conference mode, etc.

In such a manner, participants of the video conference may gain an immersive video conference experience through such a physical conference space. In addition, as will be described in detail below, such a modular physical conference space arrangement further facilitates building the desired virtual conference space more flexibly.

In some implementations, the arrangement 100 may further include a control device 140 communicatively connected with the control image capture device 120 and the display device 110. As will be described in detail below, the control device 140 may, for example, control the processes such as the capture of images of participants, and generation and display of video conference images.

In some implementations, the display device 110, the image capture device 120 and other components (semi-circular tabletop, L-shaped corner tabletop, etc.) included in the arrangement 100 may also be pre-calibrated to determine positions of all components in the arrangement 100.

### Sample Conference Modes

Employing the modular physical conference space as discussed above, embodiments of the subject matter described herein may virtualize a plurality of modular physical conference spaces as a plurality of sub-virtual spaces, and correspondingly construct virtual conference spaces with different arrangements, to support different types of conference modes. Example conference modes will be described below.

### Example 1: Face-to-Face Conference Mode

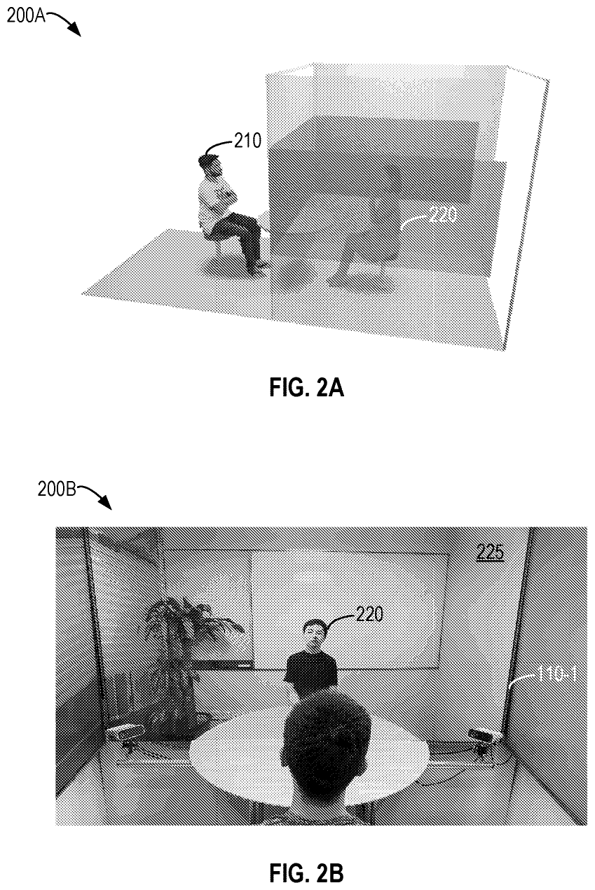

In some implementations, the conferencing system of the subject matter described herein may support a face-to-face conference mode. FIG. 2A and FIG. 2B illustrate schematic diagrams of a face-to-face conference mode according to some implementations of the subject matter described herein. As shown in FIG. 2A, in the face-to-face conference mode, the conference system may construct a virtual conference space 200A by face-to-face splicing of sub-virtual spaces corresponding to the physical conference spaces where the two participants 210 and 220 are located.

As shown in FIG. 2B, from the perspective of the participant 210, the conference system may provide a conference image 225 by using a front display device 110-1 in the physical conference space where the participant 210 is located. As shown in FIG. 2B, the conference image 225 may include a view of another participant 220. In some implementations, the conference image 225 for example may also have a virtual background, such as a background wall and a semicircular table top.

In the face-to-face conference mode, embodiments of the subject matter described herein enable two participants to have an experience as if they were meeting face-to-face at a single table.

### Example 2: Round Table Conference Mode

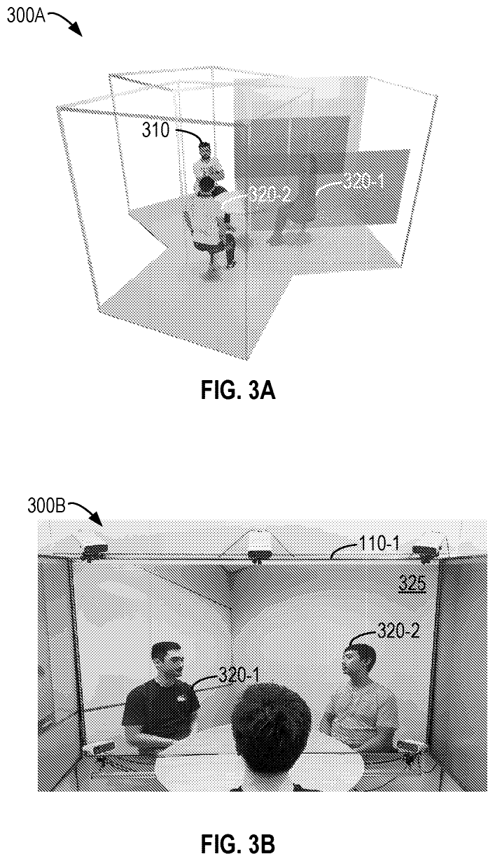

In some implementations, the conferencing system of the subject matter described herein may support a round table conference mode. FIG. 3A and FIG. 3B illustrate schematic diagrams of a round table conference mode according to some implementations of the subject matter described herein. As shown in FIG. 3A, in the round table conference mode, the conference system may construct a virtual conference space 300A by combining sub-virtual spaces corresponding to the physical conference spaces where a plurality of participants (e.g., the participants 310, 320-1 and 320-2 shown in FIG. 3A) locate. It can be seen that, different from the layout of the face-to-face conference mode, the plurality of participants may be set according to a certain angle in the round table conference mode.

As shown in FIG. 3B, from the perspective of a participant 310, the conference system may use a front display device 110-1 in the physical conference space where the participant 310 lies to provide a conference image 325. As shown in FIG. 3B, the conference image 325 may include views of participant 320-1 and participant 320-2. In some implementations, the conference image 325 may further have a virtual background, such as a background wall, a semicircular table top or an electronic whiteboard region.

In some implementations, the electronic whiteboard region for example may be used to provide video conference-related content such as a document, a picture, a video, a slideshows, and so on.

Alternatively, the content of the electronic whiteboard region may change in response to an instruction of the proper participant. For example, the electronic whiteboard region may be used to play slides, and may perform a page-turning action in response to a gesture instruction, a voice instruction, or other suitable types of instructions from the slide presenter.

In the round table conference mode, embodiments of the subject matter described herein enable participants to have the experience of having an interview with multiple other participants as if they were at one table.

### Example 3: Side-by-Side Conference Mode

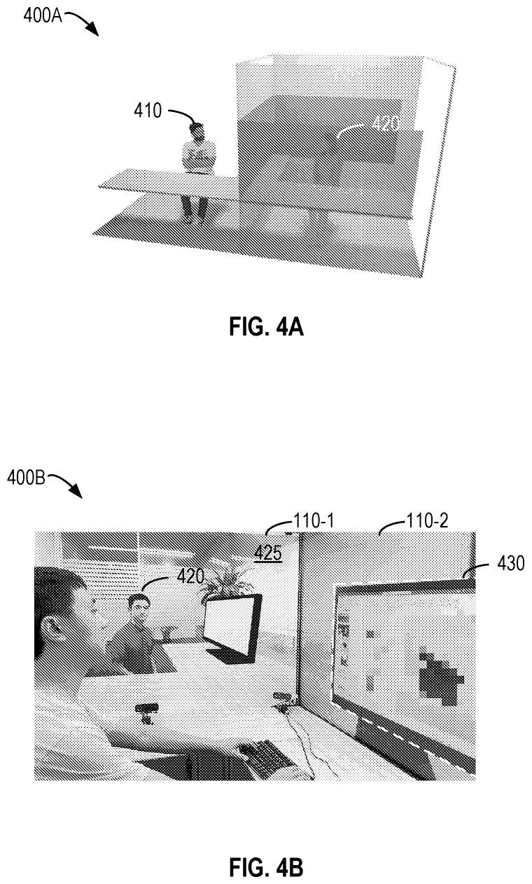

In some implementations, the conferencing system of the subject matter described herein may support a side-by-side conference mode. FIG. 4A and FIG. 4B illustrate schematic diagrams of a side-by-side conference mode according to further implementations of the subject matter described herein. As shown in FIG. 4A, in the side-by-side conference mode, the conference system may construct a virtual conference space 400A by laterally combining sub-virtual spaces corresponding to the physical conference spaces where the participants 410 and 420 are located.

It can be seen that, unlike the layout of the face-to-face conference mode, the participant 420 will be presented to a side of the participant 410 instead of the front in the side-by-side conference mode.

As shown in FIG. 4B, from the perspective of participant 410, the conference system may use display devices 110-1 and 110-2 in the physical conference space where participant 310 is located to provide a conference image 425.

As shown in FIG. 4B, the display device 110-1 on the side of the participant 410 may be used to display the view of the participant 420. In some implementations, the display device 110-1 may also display a virtual background associated with participant 420, such as a virtual table top, a virtual display positioned in front of participant 420, and so on. Thus, in the side-by-side conference mode, the participants 410 may obtain a visual experience as if he and the participant 420 were located at adjacent workstations.

In some implementations, as shown in FIG. 4B, the display device 110-2 in front of the participant 410 may also for example present an operable image region, such as a virtual screen region 430, which may support interaction. In some implementations, the virtual screen for example may be a graphical interface of a cloud operating system, and the participant 410 for example may interact with the graphic interface in a proper manner. For example, participants may use the cloud operating system to edit a document online by using a control device such as a keyboard or a mouse.

In some implementations, the virtual screen region 430 may also be presented in real time through a display device in the physical conference space where the participant 420 is located, thereby enabling online remote interaction.

In an example scenario, the participant 410 for example may modify the code in the virtual screen region 430 in real time by using a keyboard, and for example may solicit the other participant 420's opinion in real time by way of voice input. The other participant 420 may view modifications made by the participant 410 in real time through conference images, and may provide comments by way of voice input. Alternatively, the other participant 420 for example may also request for the control of the virtual screen region 430 and perform a modification through a proper control device (e.g., a mouse or a keyboard, etc.).

In another example scenario, the participant 410 and the participant 420 may respectively have a different virtual screen region, similar to different work devices in a real work scene.

Furthermore, such a virtual screen region may be implemented for example by a cloud operating system, and may support the participant 410 or the participant 420 to initiate real-time interaction between two different virtual screen regions. For example, a file may be dragged from one virtual screen region to another virtual screen region in real time.

Therefore, in the side-by-side conference mode, the implementation of the subject matter described herein may use other regions of the display device to further provide operations such as remote collaboration, thereby enriching the functions of the video conference.

In some implementations, a distance between the participant 410 and participant 420 in virtual conference space 400A may be dynamically adjusted for example based on an input, to make the two participants feel closer or farther apart.

### Other Conference Modes

Some example conference modes are described above, it should be appreciated that other suitable conference modes are possible. Exemplarily, the conference system of the subject matter described herein for example may further support a lecture conference mode, in which one or more participants for example may be designated as a speaker or speakers, and one or more other participants for example may be designated as audience. Accordingly, the conference system may construct a virtual conference scene such that for example the speaker may be drawn on one side of a platform and the audience on the other side of the platform.

It should be appreciated that other suitable virtual conference space layouts are possible. On the basis of the modular physical conference space as discussed above, the conference system of the subject matter described herein may flexibly construct different types of virtual conference space layouts as needed.

In some implementations, the conference system may automatically determine the conference mode according to the number of participants included in the video conference. For example, when it is determined that there are two participants, the system may automatically determine the face-to-face conference mode.

In some implementations, the conference system may automatically determine the conference mode according to the number of conference devices associated with the video conference. For example, when it is determined that the number of access terminals in the video conference is greater than two, the system may automatically determine the conference mode as the round table conference mode.

In some implementations, the conference system may also determine the conference mode according to configuration information associated with the video conference. For example, a participant or organizer of the video conference may configure the conference mode by inputting before initiating the video conference.

In some implementations, the conference system may also dynamically change the conferencing mode in the video conference according to the interactions of the video conference participants or in response to a change in the environment. For example, the conference system may recommend the conference mode of a two-participant conference as the face-to-face mode by default, and dynamically adjust the conference mode to the side-by-side conference mode after receiving an instruction from the participants. Alternatively, the conference system initially detects only two participants, starts the face-to-face conference mode, and may automatically switch to the round table conference mode after detecting that a new participant has joined the video conference.

### System Architecture

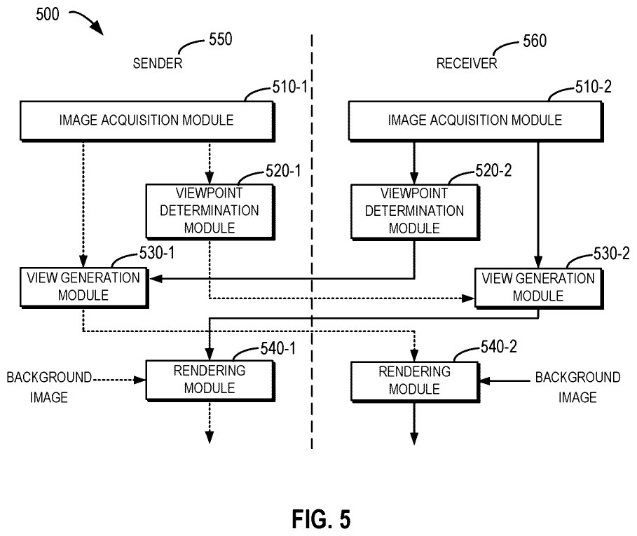

FIG. 5 illustrates a block diagram of an example architecture of a conference system 500 according to implementations of the subject matter described herein. As shown in FIG. 5, a sender 550 represents a remote participant in the conference system 500, and for example may be the participant 220 in FIG. 2A, the participants 320-1 and 320-2 in FIG. 3A, or the participant 440 in FIG. 4A. A receiver 560 represents a local participant in conference system 500, for example the participant 210 in FIG. 2A, participant 310 in FIG. 3A, or participant 410 in FIG. 4A. As shown in FIG. 5, taking the sender 550 as an example, the conference system 500 may include an image acquisition module 510-1 configured to use the image capture device 120 to acquire an image of the sender 550.

The conference system 500 further includes a viewpoint determination module 520-1 configured to determine viewpoint information of the sender 550 according to the acquired image of the sender 550. The viewpoint information may be further provided to a view generation module 530-2 corresponding to the receiver 560.

The conference system 500 further includes a view generation module 530-1 which is configured to receive the viewpoint information of the receiver 560 determined by the viewpoint determination module 520-2 corresponding to the receiver 560, and to generate a view of the sender 550 based on the image of the sender 550. The view may be further provided to a rendering module 540-2 corresponding to the receiver 560.

The conference system 500 further includes a rendering module 540-1 which is configured to generate a final conference image according to the received view and background image of the receiver 560 and provide the final conference image to the sender 550. In some implementations, the rendering module 540-1 may directly render the received view of receiver 560. Alternatively, the rendering module 540-1 may further perform corresponding processing on the received view to obtain an image of the receiver 560 for final display.

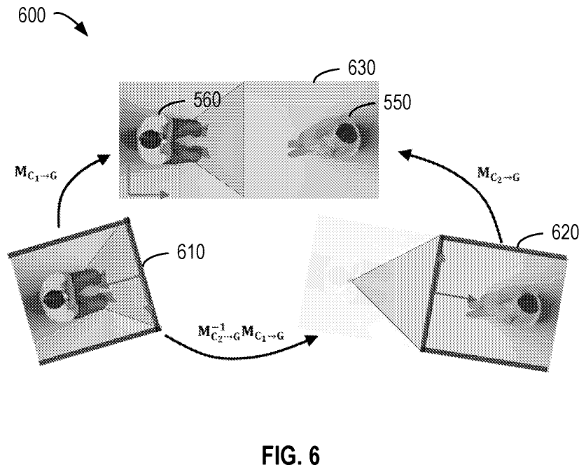

The implementation of the modules will be described in detail below with reference to FIG. 6 through FIG. 9.

### Viewpoint Determination

As described above, the viewpoint determination module 520-2 is configured to determine viewpoint information of the receiver 560 based on the captured image of the receiver 560. FIG. 6 further illustrates a schematic diagram of determining the viewpoint information according to some implementations of the subject matter described herein.

As shown in FIG. 6, the viewpoint determination module 520-1 or the viewpoint determination module 520-2 may determine a global coordinate system corresponding to a virtual conference space 630 based on layout information indicated by the conference mode. Furthermore, the viewpoint determination module 520 may further determine a coordinate transformation M_{C}_{_{2→G}} from a first physical conference space 620 of the sender 550 to a virtual conference space 630, and a coordinate transformation M_{C}_{_{1→G}} from a second physical conference space 610 of the receiver 560 to a virtual conference space, thereby determining a coordinate transformation M_{C}_{_{2→G}}⁻¹M_{C}_{_{1→G}} from the second physical conference space 610 to the first physical conference space 620.

Furthermore, the viewpoint determination module 520-1 or the viewpoint determination module 520-2 may determine a first viewpoint position of the receiver 560 in the second physical conference space 610. In some implementations, the viewpoint position may be determined by detecting facial features of receiver 560. Exemplarily, the viewpoint determination module 520 may detect positions of the receiver 560's both eyes and determine a midpoint position of the both eyes as the first viewpoint position of the receiver 560. It should be appreciated that other suitable feature points may also be used to determine the first viewpoint position of the receiver 560.

In some implementations, to determine the first viewpoint position, the system may first be calibrated to determine a relative positional relationship between display device 110 and image capture device 120, as well as their positions relative to the ground.

Furthermore, the image acquisition module 510-2 may acquire a plurality of images from the image capture devices 120 for each frame, and the number of images depends on the number of the image capture devices 120. Face detection may be performed on each image. If a face can be detected, pixel coordinates of centers of eyeballs of the both eyes are obtained and a midpoint of the two pixels is taken as the viewpoint. If the face cannot be detected, or a plurality of faces are detected, this image is skipped.

In some implementations, if eyes can be detected from two or more images, 3-dimensional coordinates eye_pos of the viewpoint of the current frame are calculated by triangulation. Then, the 3-dimensional coordinates eye_pos of the viewpoint of the current frame are filtered. A filtering method is eye_pos′=w*eye_pos+(1−w)*eye_pos_prev, where eye_pos_prev is the 3D coordinates of the viewpoint of a previous frame, and w is a weight coefficient of the current viewpoint. The weight coefficient may for example be proportional to a distance L (meters) between eye_pos and eye_pos_prev, and a time interval T (seconds) between two frames. Exemplarily, w may be determined as (100*L)*(5*T), and finally its value is truncated between 0 and 1.

In some implementations, the viewpoint determination module 520-1 or the viewpoint determination module 520-2 transforms the first viewpoint position into a second viewpoint position (also referred to as a virtual viewpoint) in the physical conference space 620 according to the coordinate transformation M_{C}_{_{2→G}}⁻¹M_{C}_{_{1→G}} from the second physical conference space 610 to the first physical conference space 620, and the second viewpoint position may further be used to determine the viewpoint information of the view of the sender 550.

Exemplarily, the viewpoint determination module 520-2 of the receiver 560 may determine the second viewpoint position of the receiver 560, and send the second viewpoint position to the sender 550. Alternatively, the viewpoint determination module 520-2 of the receiver 560 may determine the first viewpoint position of the receiver 560, and send the first viewpoint position to the sender 550, so that the viewpoint determination module 520-1 may determine the second viewpoint position of the receiver 560 in the first physical conference space 620 according to the first viewpoint position.

By sending the viewpoint position of the receiver 560 to the sender 550 for determining the view of the sender 550, the implementation of the subject matter described herein may save the transmission of the captured images to the sender 550, thereby reducing the overhead of network transmission and reducing the transmission delay of the video conference.

### View Generation

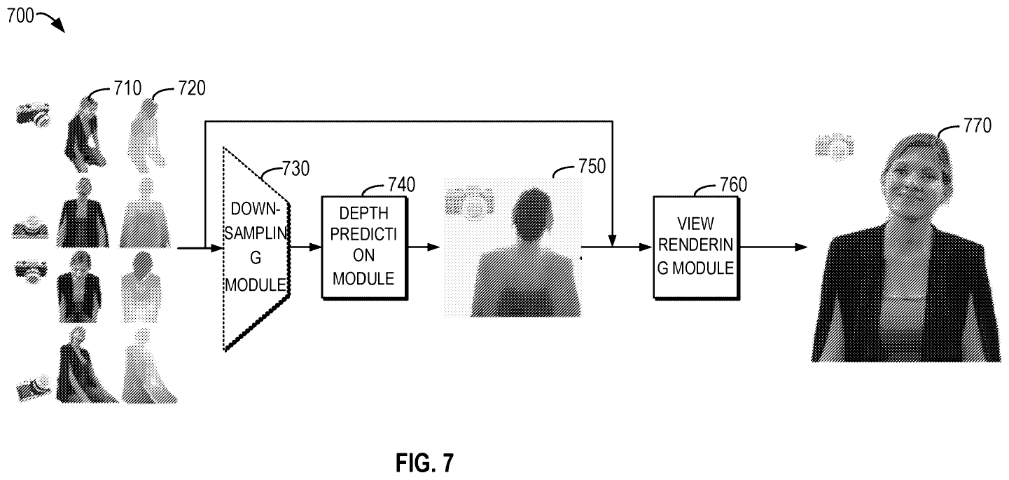

As described above, the view generation module 530-1 is configured to generate a view of the sender 550 based on the captured image of the sender 550 and the viewpoint information of the receiver 560. FIG. 7 further illustrates a schematic diagram 700 of a view generation module in accordance with some implementations of the subject matter described herein.

As shown in FIG. 7, the view generation module 530-1 mainly includes a depth prediction module 740 and a view rendering module 760. The depth prediction module 740 is configured to determine a target depth map 750 based on set of images 710 of sender 550 captured by a set of image capture devices 120 and a corresponding set of depth maps 720. The view rendering module 760 is configured to generate a view 770 of the sender 550 based further on the target depth map 750, the set of images 710, and the set of depth maps 720.

In some implementations, the view generation module 540-1 may perform image segmentation on the set of images 710 to retain image portions associated with sender 550. It should be appreciated that any suitable image segmentation algorithm may be employed to process the set of images 710.

In some implementations, the set of images 710 for determining the target depth map 750 and the view 770 may be selected from a plurality of image capture devices for capturing images of the sender 550 based on viewpoint information. Exemplarily, taking the arrangement 100 shown in FIG. 1 as an example, the image capture device for example may include six depth cameras mounted at different positions.

In some implementations, the view generation module 530-1 may determine a set of image capture devices from the plurality of image capture devices based on a distance between the viewpoint position indicated by the viewpoint information and mounting positions of the plurality of image capture devices for capturing the images of the first participant, and acquire the set of images 710 captured by the set of image capture devices and the corresponding depth maps 720. For example, the view generation module 530 may select four depth cameras which are mounted at distances closest to the viewpoint position, and acquire images captured by the four depth cameras.

In some implementations, to improve the processing efficiency, the view generation module 530-1 may further include a downsampling module 730 to downsample the set of images 710 and the set of depth maps 720 to improve the operation efficiency.

### Depth Prediction

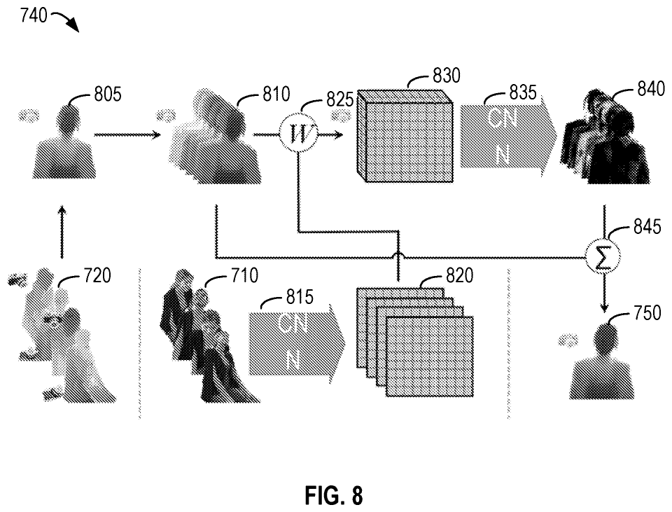

A specific implementation of the depth prediction module 740 will be described in detail below with reference to FIG. 8. As shown in FIG. 8, the depth prediction module 740 may firstly project a set of depth maps 720, denoted as {Dᵢ}, to a virtual viewpoint indicated by the viewpoint information to obtain a projected depth map {D′ᵢ}. Furthermore, the virtual viewpoint depth prediction module 740 may obtain an initial depth map 805 by averaging:

$$\overline{D} = \frac{{\sum }_{i} {M}_{i}^{′} \cdot {D}_{i}^{′}}{{\sum }_{i} {M}_{i}^{′}} \qquad ( 1 )$$

where, M′ᵢ represents the visibility mask of {D′ᵢ}.

Furthermore, the depth prediction module 740 may further construct a set of candidate depth maps 810 based on the initial depth map 805. Specifically, the depth prediction module 740 may define a depth correction range [−Δd, Δd], and evenly sample N correction values {σₖ} from this range and add them to the initial depth map 805 to determine the set of candidate depth maps 810:

$${\hat{D}}_{k} = \overline{D} + {σ}_{k} , k = 0 , … , N - 1 \qquad ( 2 )$$

Furthermore, the depth prediction module 740 may determine probability information associated with the set of candidate depth maps 810 by warping the set of maps 720 to a virtual viewpoint by using the set of candidate depth maps 810.

Specifically, as shown in FIG. 8, the depth prediction module 740 may use a convolutional neural network CNN 815 to process the set of images 710, denoted {Iᵢ}, to determine a set of image features 820, denoted as {Fᵢ}. Furthermore, the depth prediction module 740 may include a warping module 825 configured to warp a set of image features 820 to a virtual viewpoint according to a set of virtual depth maps 710.

Further, the warping module 825 may further calculate a feature variance between a plurality of image features warped through different depth maps, as the cost of corresponding pixel points. Exemplarily, a cost matrix 830 may be represented as H×W×N×C, where H represents a height of the image, W represents a width of the image, and C represents the number of feature channels.

Furthermore, the depth prediction module 740 may use a convolutional neural network CNN 835 to process the cost matrix 830 to determine probability information 840 associated with the set of candidate depth maps 810, denoted as P, whose size is H×W×N.

Furthermore, the depth prediction module 740 further includes a weighting module 845 configured to determine the target depth map 750 in accordance with the set of candidate depth maps 710 based on the probability information:

$$D = {\sum }_{k = 1}^{N} {P}_{k} \cdot {\hat{D}}_{k} \qquad ( 3 )$$

In such a manner, implementations of the subject matter described herein may determine more accurate depth maps.

### View Rendering

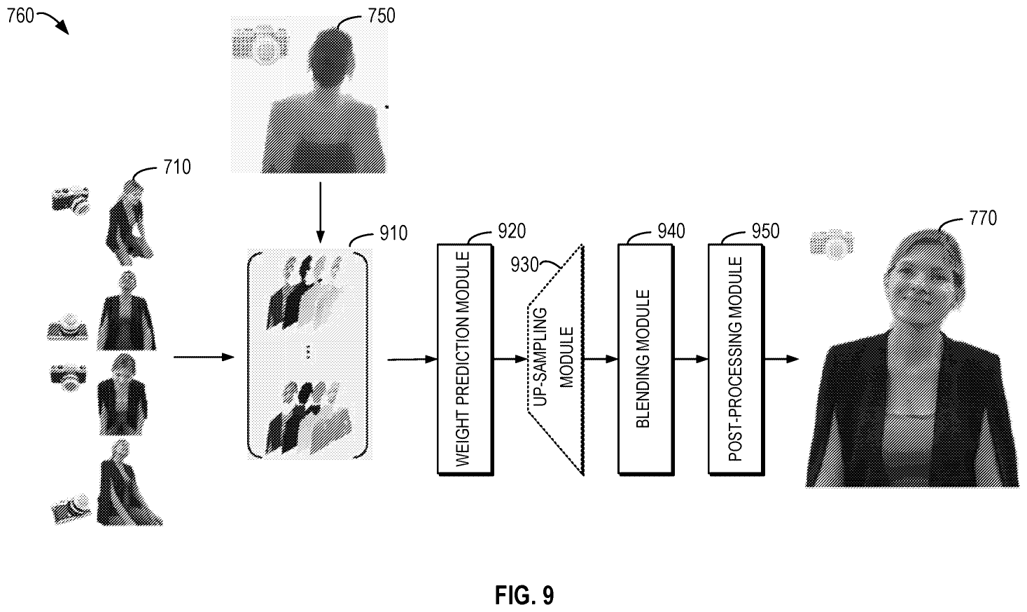

A specific implementation of the view rendering module 760 will be described in detail below with reference to FIG. 9. As shown in FIG. 9, the view rendering module 760 may include a weight prediction module 920 configured to determine a set of blending weights based on input features 910.

In some implementations, the weight prediction module 930 for example may be implemented as a machine learning model such as a convolutional neural network. In some implementations, the input features 910 to the machine learning model may include features of a set of projected images, for example may be represented as {Iᵢ^{w}=warp(Iᵢ|D)}. In some implementations, the set of projected images is determined by projecting the set of images 710 onto the virtual viewpoint according to the target depth map 750.

In some implementations, the input features 910 may also include a visibility mask Mᵢ^{w} corresponding to the set of projected images.

In some implementations, the input features 910 may further include depth difference information associated with a set of image capture viewpoints, wherein the set of image capture viewpoints indicate viewpoint positions of the set of image capture devices 120. Specifically, for each pixel p in the depth map D, the view rendering module 760 may determine the depth information Dᵢ^{w}. Specifically, the view rendering module 760 may project the depth map D to the set of image capture viewpoints to determine the set of projected depth maps. Furthermore, the view rendering module 760 may further warp the set of depth maps back to the virtual viewpoint to determine the depth information Dᵢ^{w} Further, the view rendering module 760 may determine a difference ΔDᵢ=Dᵢ^{w}−D between the two. It should be appreciated that the warping operation is intended to represent the correspondence of pixels in the projected depth maps to corresponding pixels in the depth map D, without changing the depth values of the pixels in the projected depth maps.

In some implementations, the input features 910 may further include angle difference information, wherein the angle difference information indicates a difference between a first angle associated with the corresponding image capture viewpoint and a second angle associated with the virtual viewpoint, the first angle is determined based on a surface point corresponding to a pixel in the target depth map and a corresponding image capture viewpoint, and the second angle is determined based on the surface point and the virtual viewpoint.

Specifically, for the first capture viewpoint in the set of image capture viewpoints, the view rendering module 760 may determine the first angle from the surface point corresponding to the pixel in the depth map D to the first capture viewpoint, denoted as Nᵢ^{w}. Furthermore, the view rendering module 760 may further determine a second angle from the surface point to the virtual viewpoint, denoted as N. Furthermore, the view rendering module 760 may determine angle difference information denoted as ΔNᵢ=Nᵢ^{w}−N, based on the first angle and the second angle.

In some implementations, the input feature 910 may be represented as (Iᵢ^{w}, Mᵢ^{w}, ΔDᵢ, ΔNᵢ) It should be appreciated that the view rendering module 760 may also use only part of the above information as the input features 910.

Furthermore, the weight prediction module 920 may determine the set of blending weights based on the input features 910. In some implementations, as shown in FIG. 9, the view rendering module 760 may further include an upsampling module 930 to upsample the set of blending weights to obtain weight information Wᵢ that matches an original resolution. Furthermore, the weight prediction module 920 for example may further normalize the weight information:

$${\tilde{W}}_{i} = \frac{exp ( {W}_{i} )}{{\sum }_{j} exp ( {W}_{i} )} \qquad ( 4 )$$

Furthermore, the view rendering module 760 may include a blending module 940 to blend the set of projected images based on the determined weight information to determine a blended image:

$${I}^{b} = {\sum }_{j} {\tilde{W}}_{i} \cdot {I}_{i}^{w} \qquad ( 5 )$$

In some implementations, the weight prediction module 920 may further include a post-processing module 950 to determine the first view 770 based on the blended image. In some embodiments, the post-processing module 950 may include a convolutional neural network for performing post-processing operations on the blended image, which exemplarily include but are not limited to refining silhouette boundaries, filling holes, or optimizing face regions.

Based on the view rendering module described above, by considering the depth difference and angle difference in the process of determining the blending weights, implementations of the subject matter described herein can improve the weights of images with a smaller depth difference and/or a smaller angle difference in the blending process, thereby further improving the quality of the generated views.

### Model Training

As described with reference to FIG. 7 through FIG. 9, the view generation module 530-1 may include a plurality of machine learning models. In some implementations, the plurality of machine learning models may be trained collaboratively through end-to-end training.

In some implementations, a loss function for training may include a difference between the blended image I^{a} based on the target depth map and warped images {I′ᵢ} resulting from the warping of the set of images 710:

$${color - mv}_{d}^{} = {\sum }_{i} {\sum }_{X} {M}_{i}^{w} ( x ) \cdot {‖ {I}^{a} ( x ) - {I}_{i}^{′} ( x ) ‖}_{1} , {I}^{a} = \frac{{\sum }_{i} {M}_{i}^{w} \cdot {I}_{i}^{w}}{{\sum }_{i} {M}_{i}^{w}} \qquad ( 6 )$$

where x represents an image pixel, M=∪ᵢM′ᵢ, represents a valid pixel mask of I^{a}, and ∥·∥₁ represents the l₁ norm.

In some implementations, the loss function for training may include a difference between the blended image I^{a} and a ground-truth image I*:

$${color - gt}_{d}^{} = {\sum }_{X} M ( x ) \cdot {‖ {I}^{a} ( x ) - {I}^{*} ( x ) ‖}_{1} \qquad ( 7 )$$

where the ground-truth image may, for example, be obtained with an additional image capture device.

In some implementations, the loss function for training may include a smoothness loss of the depth maps:

$${smooth}_{d}^{} = {\sum }_{X} \vert {∇}^{2} D ( x ) \vert \qquad ( 8 )$$

where ∇² represents the Laplace operator.

In some implementations, the loss function for training may include a difference between the blended image output by the blending module 940 and the ground-truth image I*:

$${color}_{l}^{} = {\sum }_{X} M ( x ) \cdot {‖ {I}^{b} ( x ) - {I}^{*} ( x ) ‖}_{1} \qquad ( 9 )$$

In some implementations, the loss function for training may include a rgba difference between the view output by the post-processing module 950 and the ground-truth image I*:

$${rgba - gt}_{r}^{} = {\sum }_{X} {‖ α ( x ) \cdot I ( x ) - {α}^{*} ( x ) \cdot {I}^{*} ( x ) ‖}_{1} \qquad ( 10 )$$

In some implementations, the loss function for training may include a color difference between the view output by the post-processing module 950 and the ground-truth image I*:

$${color - input}_{r}^{} = {\sum }_{X} α ( x ) \cdot M ( x ) \cdot {‖ I ( x ) - {I}^{b} ( x ) ‖}_{1} \qquad ( 11 )$$

In some implementations, the loss function for training may include an α-graph loss:

$${α}_{r}^{} = {\sum }_{X} {‖ α ( x ) - {α}^{*} ( x ) ‖}_{1} \qquad ( 12 )$$

In some implementations, the loss function for training may be a perceptual loss associated with a face region:

$${face}_{r}^{} = {\sum }_{l} {‖ {ϕ}_{l} ( crop ( I ) ) - {ϕ}_{l} ( crop ( {I}^{*} ) ) ‖}_{1} \qquad ( 13 )$$

where crop(·) denotes a face bounding box cropping operation, and ϕₗ(·) represents a feature extraction operation of the trained network.

In some implementations, the loss function for training may include a GAN loss:

$${adv}_{r}^{} = {‖ D ( I ) - 1 ‖}^{2} \qquad ( 14 )$$

where D represents a discriminator network.

In some implementations, the loss function for training may include an adversarial loss:

$${adv - D}_{r}^{} = \frac{1}{2} {‖ D ( I ) - 0 ‖}^{2} + \frac{1}{2} {‖ D ( {I}^{*} ) - 1 ‖}^{2} \qquad ( 15 )$$

It should be appreciated that a combination of one or more of the above loss functions may be used as an objective function for training the view generation module 530-1.

### Example Process

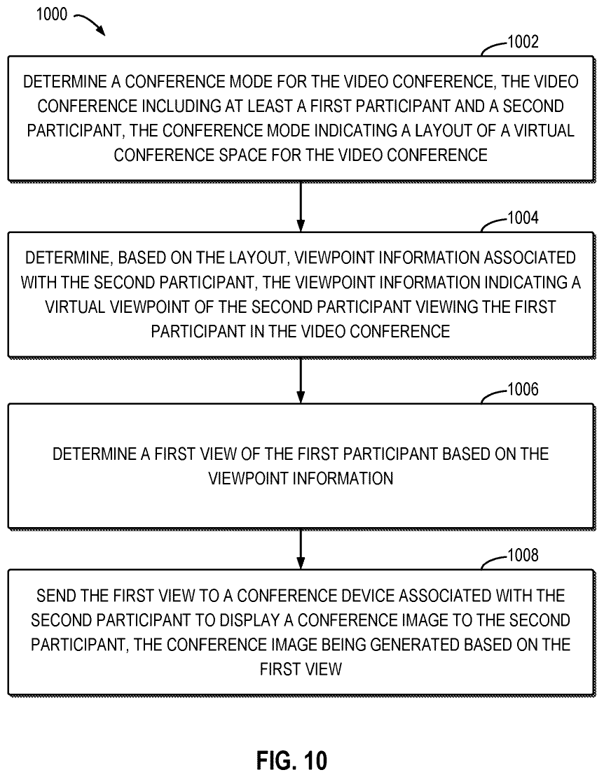

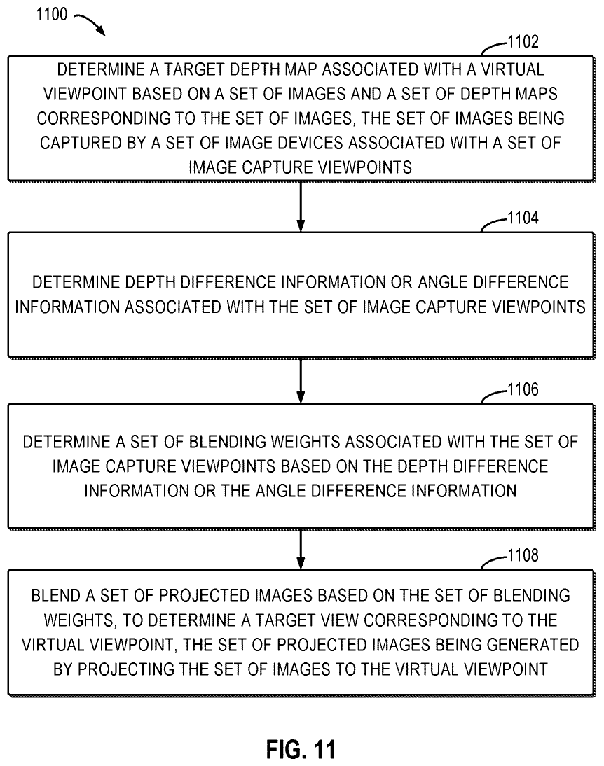

FIG. 10 illustrates a flowchart of an example process 1000 for a video conference according to some implementations of the subject matter described herein. The process 1000 may be implemented, for example, by a control device 140 in FIG. 1 or other suitable device, such as a device 1100 to be discussed with reference FIG. 11.

As shown in FIG. 10, at block 1002, the control device 140 determines a conference mode for the video conference, the video conference including at least a first participant and a second participant, the conference mode indicating a layout of a virtual conference space for the video conference.

At block 1004, the control device 140 determines, based on the layout, viewpoint information associated with the second participant, the viewpoint information indicating a virtual viewpoint of the second participant viewing the first participant in the video conference.

At block 1006, the control device 140 determines a first view of the first participant based on the viewpoint information.

At block 1008, the control device 140 sends the first view to a conference device associated with the second participant to display a conference image to the second participant, the conference image being generated based on the first view.

In some implementations, the virtual conference space includes a first sub-virtual space and a second sub-virtual space, the first sub-virtual space is determined by virtualizing a first physical conference space where the first participant is located, the layout indicating a distribution of the first sub-virtual space and the second sub-virtual space in the virtual conference space, and the second sub-virtual space is determined by virtualizing a second physical conference space where the second participant is located.

In some implementations, determining the viewpoint information associated with the second participant based on the layout includes: determining, based on the layout, a first coordinate transformation between the first physical conference space and the virtual conference space and a second coordinate transformation between the second physical conference space and the virtual conference space; transforming, based on the first coordinate transformation and the second coordinate transformation, a first viewpoint position of the second participant in the second physical conference space into a second viewpoint position in the first physical conference space; and determining viewpoint information based on the second viewpoint position.

In some implementations, the first viewpoint position is determined by detecting a facial feature point of the second participant.

In some implementations, generating the first view of the first participant based on the viewpoint information includes: acquiring a set of images of the first participant captured by a set of image capture devices, the set of images corresponding to a set of depth maps; determining a target depth map corresponding to the viewpoint information, based on the set of images and the set of depth maps; and determining the first view of the first participant corresponding to the viewpoint information based on the target depth map and the set of images.

In some implementations, the method further includes: determining the set of image capture devices from a plurality of image capture devices for capturing the images of the first participant, based on a distance between the viewpoint position indicated by the viewpoint information and mounting positions of the plurality of image capture devices.

In some implementations, the video conference further includes a third participant, and the generation of the conference image is also based on the third participant's second view.

In some implementations, the conference image further includes an operable image region, graphical elements in the operable image region change in response to an interaction action of the first participant or the second participant.

In some implementations, the conference mode includes at least one of a face-to-face conference mode, a multi-participant round table conference mode, a side-by-side conference mode, or a lecture conference mode.

In some implementations, determining the conference mode for the video conference includes: determining the conference mode based on at least one of: the number of participants included in the video conference, the number of conference devices associated with the video conference, or configuration information associated with the video conference.

FIG. 11 illustrates a flowchart of an example process for determining a view according to some implementations of the subject matter described herein. The process 1100 may be implemented, for example, by a control device 140 in FIG. 1 or other suitable device, such as device 1100 to be discussed with reference to FIG. 11.

As shown in FIG. 11, at block 1102, the control device 140 determines a target depth map associated with a virtual viewpoint based on a set of images and a set of depth maps corresponding to the set of images, the set of images being captured by a set of image devices associated with a set of image capture viewpoints.

At block 1104, the control device 140 determines depth difference information or angle difference information associated with the set of image capture viewpoints; wherein the depth difference information indicates a difference between depths of pixels in projected depth maps corresponding to respective image capture viewpoints and depths of corresponding pixels in the target depth map, the projected depth map being determined by projecting the target depth map to the corresponding image capture viewpoint, and the angle difference information indicates a difference between a first angle associated with the corresponding image capture viewpoint and a second angle associated with the virtual viewpoint, the first angle is determined based on a surface point corresponding to a pixel in the target depth map and a corresponding image capture viewpoint, and the second angle is determined based on the surface point and the virtual viewpoint.

At block 1106, the control device 140 determines a set of blending weights associated with the set of image capture viewpoints based on the depth difference information or the angle difference information.

At block 1108, the control device 140 blends a set of projected images based on the set of blending weights, to determine a target view corresponding to the virtual viewpoint, the set of projected images being generated by projecting the set of images to the virtual viewpoint. In some implementations, determining a target depth map associated with the virtual viewpoint includes: down-sampling the set of images and the set of depth maps; and determining the target depth map corresponding to the viewpoint information by using the down-sampled set of images and the down-sampled set of depth maps.

In some implementations, blending the set of projected images based on the set of blending weights includes: up-sampling the set of blending weights to determine weight information; and blending the set of projected images based on the weight information, to determine the target view corresponding to the virtual viewpoint.

In some implementations, determining the target depth map associated with the virtual viewpoint includes: determining an initial depth map corresponding to the virtual viewpoint based on the set of depth maps; constructing a set of candidate depth maps based on the initial depth map; determining probability information associated with the set of candidate depth maps by using the set of candidate depth maps to warp the set of images to the virtual viewpoint; and determining the target depth map in accordance with the set of candidate depth maps based on the probability information.

In some implementations, blending the set of projected images based on the set of blending weights includes: blending the set of projected images based on the set of blending weights, to determine a blended image; and the method further includes: using a neural network to perform post-processing on the blended image to determine a target view.

### Example Device

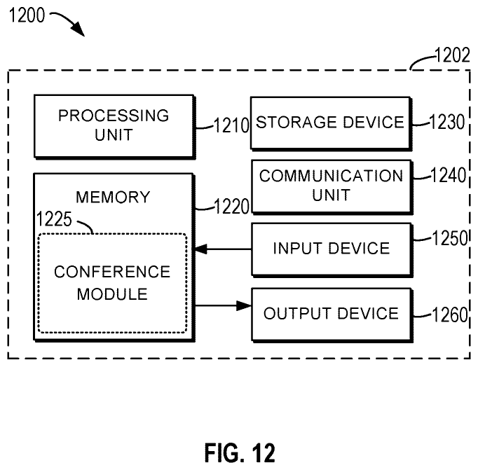

FIG. 12 illustrates a block diagram of an example device 1200 in which implementations of the subject matter described herein can be implemented. It would be appreciated that the device 1200 as shown in FIG. 12 is merely provided as an example, without suggesting any limitation to the functionalities and scope of implementations of the subject matter described herein. As shown in FIG. 12, components of the device 1200 can include, but are not limited to, one or more processors or processing units 1210, a memory 1220, a storage device 1230, one or more communication units 1240, one or more input devices 1250, and one or more output devices 1260.

In some implementations, the device 1200 can be implemented as various user terminals or server ends. The service ends may be any server, large-scale computing device, and the like provided by various service providers. The user terminal may be, for example, any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, TV receiver, radio broadcast receiver, E-book device, gaming device or any combinations thereof, including accessories and peripherals of these devices or any combinations thereof. It would be appreciated that the computing device 1200 can support any type of interface for a user (such as “wearable” circuitry and the like).

The processing unit 1210 can be a physical or virtual processor and can implement various processes based on programs stored in the memory 1220. In a multi-processor system, a plurality of processing units execute computer-executable instructions in parallel so as to improve the parallel processing capability of the device 1200. The processing unit 1210 may also be referred to as a central processing unit (CPU), a microprocessor, a controller and a microcontroller.

The 1200 usually includes various computer storage medium. Such a medium may be any available medium accessible by the device 1200, including but not limited to, volatile and non-volatile medium, or detachable and non-detachable medium. The memory 1220 can be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof. The memory 1220 may include one or more conferencing modules 1225, which are program modules configured to perform various video conference functions in various implementations described herein. The conference module 1225 may be accessed and run by the processing unit 1210 to perform corresponding functions. The storage device 1230 may be any detachable or non-detachable medium and may include machine-readable medium which can be used for storing information and/or data and accessed in the device 1200.

The functions of the components of device 1200 may be implemented with a single computing cluster or multiple computing machines which are capable of communicating over a communication connection. Therefore, the device 1200 can operate in a networked environment using a logical connection with one or more other servers, personal computers (PCs) or further general network nodes. By means of the communication unit 1240, the device 1200 can further communicate with one or more external devices (not shown) such as databases, other storage devices, servers and display devices, with one or more devices enabling the user to interact with the device 1200, or with any devices (such as a network card, a modem and the like) enabling the device 1200 to communicate with one or more other computing devices, if required. Such communication may be performed via input/output (I/O) interfaces (not shown).

The input device 1250 may include one or more of various input devices, such as a mouse, keyboard, tracking ball, voice-input device, camera and the like. The output device 1260 may include one or more of various output devices, such as a display, loudspeaker, printer, and the like.

### Example Implementations

Some example implementations of the subject matter described herein are listed below.

In a first aspect, the subject matter described herein provides a method for a video conference. The method includes: determining a conference mode for the video conference, the video conference including at least a first participant and a second participant, the conference mode indicating a layout of a virtual conference space for the video conference; determining, based on the layout, viewpoint information associated with the second participant, the viewpoint information indicating a virtual viewpoint of the second participant viewing the first participant in the video conference; determining a first view of the first participant based on the viewpoint information; and sending the first view to a conference device associated with the second participant to display a conference image to the second participant, the conference image being generated based on the first view.

In some implementations, the virtual conference space includes a first sub-virtual space and a second sub-virtual space, the layout indicating a distribution of the first sub-virtual space and the second sub-virtual space in the virtual conference space, the first sub-virtual space being determined by virtualizing a first physical conference space where the first participant is located, the second sub-virtual space being determined by virtualizing a second physical conference space where the second participant is located.

In some implementations, determining the viewpoint information associated with the second participant based on the layout includes: determining, based on the layout, a first coordinate transformation between the first physical conference space and the virtual conference space and a second coordinate transformation between the second physical conference space and the virtual conference space; transforming, based on the first coordinate transformation and the second coordinate transformation, a first viewpoint position of the second participant in the second physical conference space into a second viewpoint position in the first physical conference space; and determining viewpoint information based on the second viewpoint position.

In some implementations, the first viewpoint position is determined by detecting a facial feature point of the second participant.

In some implementations, generating the first view of the first participant based on the viewpoint information includes: acquiring a set of images of the first participant captured by a set of image capture devices, the set of images corresponding to a set of depth maps; determining a target depth map corresponding to the viewpoint information, based on the set of images and the set of depth maps; and determining the first view of the first participant corresponding to the viewpoint information based on the target depth map and the set of images.

In some implementations, the method further includes: determining the set of image capture devices from a plurality of image capture devices for capturing the images of the first participant, based on a distance between the viewpoint position indicated by the viewpoint information and mounting positions of the plurality of image capture devices.

In some implementations, the video conference further includes a third participant, and the generation of the conference image is also based on the third participant's second view.

In some implementations, the conference image further includes an operable image region, graphical elements in the operable image region change in response to an interaction action of the first participant or the second participant.

In some implementations, the conference mode includes at least one of a face-to-face conference mode, a multi-participant round table conference mode, a side-by-side conference mode, or a lecture conference mode.

In some implementations, determining the conference mode for the video conference includes: determining the conference mode based on at least one of: the number of participants included in the video conference, the number of conference devices associated with the video conference, or configuration information associated with the video conference.

In a second aspect, the subject matter described herein provides an electronic device. The electronic device comprises: a processing unit; and a memory coupled to the processing unit and having instructions stored thereon, the instructions, when executed by the processing unit, causing the device to perform acts of: determining a conference mode for the video conference, the video conference including at least a first participant and a second participant, the conference mode indicating a layout of a virtual conference space for the video conference; determining, based on the layout, viewpoint information associated with the second participant, the viewpoint information indicating a virtual viewpoint of the second participant viewing the first participant in the video conference; determining a first view of the first participant based on the viewpoint information; and sending the first view to a conference device associated with the second participant to display a conference image to the second participant, the conference image being generated based on the first view.

In some implementations, the virtual conference space includes a first sub-virtual space and a second sub-virtual space, the layout indicating a distribution of the first sub-virtual space and the second sub-virtual space in the virtual conference space, the first sub-virtual space being determined by virtualizing a first physical conference space where the first participant is located, the second sub-virtual space being determined by virtualizing a second physical conference space where the second participant is located.

In some implementations, determining the viewpoint information associated with the second participant based on the layout includes: determining, based on the layout, a first coordinate transformation between the first physical conference space and the virtual conference space and a second coordinate transformation between second physical conference space and the virtual conference space; transforming, based on the first coordinate transformation and the second coordinate transformation, a first viewpoint position of the second participant in the second physical conference space into a second viewpoint position in the first physical conference space; and determining viewpoint information based on the second viewpoint position.

In some implementations, the first viewpoint position is determined by detecting a facial feature point of the second participant.

In some implementations, generating the first view of the first participant based on the viewpoint information includes: acquiring a set of images of the first participant captured by a set of image capture devices, the set of images corresponding to a set of depth maps; determining a target depth map corresponding to the viewpoint information, based on the set of images and the set of depth maps; and determining the first view of the first participant corresponding to the viewpoint information based on the target depth map and the set of images.

In some implementations, the method further includes: determining the set of image capture devices from a plurality of image capture devices for capturing the images of the first participant, based on a distance between the viewpoint position indicated by the viewpoint information and mounting positions of the plurality of image capture devices.

In some implementations, the video conference further includes a third participant, and the generation of the conference image is also based on the third participant's second view.

In some implementations, the conference image further includes an operable image region, graphical elements in the operable image region change in response to an interaction action of the first participant or the second participant.

In some implementations, the conference mode includes at least one of a face-to-face conference mode, a multi-participant round table conference mode, a side-by-side conference mode, or a lecture conference mode.

In some implementations, determining the conference mode for the video conference includes: determining the conference mode based on at least one of: the number of participants included in the video conference, the number of conference devices associated with the video conference, or configuration information associated with the video conference.

In a third aspect, the subject matter described herein provides a computer program product that is tangibly stored on a non-transitory computer storage medium and includes machine-executable instructions, the machine-executable instructions, when being executed by a device, cause the device to perform the following actions: determining a conference mode for the video conference, the video conference including at least a first participant and a second participant, the conference mode indicating a layout of a virtual conference space for the video conference; determining, based on the layout, viewpoint information associated with the second participant, the viewpoint information indicating a virtual viewpoint of the second participant viewing the first participant in the video conference; determining a first view of the first participant based on the viewpoint information; and sending the first view to a conference device associated with the second participant to display a conference image to the second participant, the conference image being generated based on the first view.

In some implementations, the virtual conference space includes a first sub-virtual space and a second sub-virtual space, the layout indicating a distribution of the first sub-virtual space and the second sub-virtual space in the virtual conference space, the first sub-virtual space being determined by virtualizing a first physical conference space where the first participant is located, the second sub-virtual space being determined by virtualizing a second physical conference space where the second participant is located.

In some implementations, determining the viewpoint information associated with the second participant based on the layout includes: determining, based on the layout, a first coordinate transformation between the first physical conference space and the virtual conference space and a second coordinate transformation between second physical conference space and the virtual conference space; transforming, based on the first coordinate transformation and the second coordinate transformation, a first viewpoint position of the second participant in the second physical conference space into a second viewpoint position in the first physical conference space; and determining viewpoint information based on the second viewpoint position.

In some implementations, the first viewpoint position is determined by detecting a facial feature point of the second participant.

In some implementations, generating the first view of the first participant based on the viewpoint information includes: acquiring a set of images of the first participant captured by a set of image capture devices, the set of images corresponding to a set of depth maps; determining a target depth map corresponding to the viewpoint information, based on the set of images and the set of depth maps; and determining the first view of the first participant corresponding to the viewpoint information based on the target depth map and the set of images.

In some implementations, the method further includes: determining the set of image capture devices from a plurality of image capture devices for capturing the images of the first participant, based on a distance between the viewpoint position indicated by the viewpoint information and mounting positions of the plurality of image capture devices.

In some implementations, the video conference further includes a third participant, and the generation of the conference image is also based on the third participant's second view.

In some implementations, the conference image further includes an operable image region, graphical elements in the operable image region change in response to an interaction action of the first participant or the second participant.

In some implementations, the conference mode includes at least one of a face-to-face conference mode, a multi-participant round table conference mode, a side-by-side conference mode, or a lecture conference mode.

In some implementations, determining the conference mode for the video conference includes: determining the conference mode based on at least one of: the number of participants included in the video conference, the number of conference devices associated with the video conference, or configuration information associated with the video conference.

In a fourth aspect, the subject matter described herein provides a method for a video conference.

The method includes: determining a target depth map associated with a virtual viewpoint based on a set of images and a set of depth maps corresponding to the set of images, the set of images being captured by a set of image devices associated with a set of image capture viewpoints; determining depth difference information or angle difference information associated with the set of image capture viewpoints; wherein the depth difference information indicates a difference between depths of pixels in projected depth maps corresponding to respective image capture viewpoints and depths of corresponding pixels in a target depth map, the projected depth map being determined by projecting the target depth map to the corresponding image capture viewpoint, and the angle difference information indicates a difference between a first angle associated with the corresponding image capture viewpoint and a second angle associated with the virtual viewpoint, the first angle is determined based on a surface point corresponding to a pixel in the target depth map and a corresponding image capture viewpoint, and the second angle is determined based on the surface point and the virtual viewpoint; determining a set of blending weights associated with the set of image capture viewpoints based on the depth difference information or the angle difference information; blending a set of projected images based on the set of blending weights, to determine a target view corresponding to the virtual viewpoint, the set of projected images being generated by projecting the set of images to the virtual viewpoint.

In some implementations, determining a target depth map associated with the virtual viewpoint includes: down-sampling the set of images and the set of depth maps; and determining the target depth map corresponding to the viewpoint information, by using the down-sampled set of images and the down-sampled set of depth maps.

In some implementations, blending the set of projected images based on the set of blending weights includes: up-sampling the set of blending weights to determine weight information; and blending the set of projected images based on the weight information, to determine the target view corresponding to the virtual viewpoint.

In some implementations, determining the target depth map associated with the virtual viewpoint includes: determining an initial depth map corresponding to the virtual viewpoint based on the set of depth maps; constructing a set of candidate depth maps based on the initial depth map; determining probability information associated with the set of candidate depth maps by using the set of candidate depth maps to warp the set of images to the virtual viewpoint; and determining the target depth map in accordance with the set of candidate depth maps based on the probability information.

In some implementations, blending the set of projected images based on the set of blending weights includes: blending the set of projected images based on the set of blending weights, to determine a blended image; and the method further includes: using a neural network to perform post-processing on the blended image to determine a target view.

In a fifth aspect, the subject matter described herein provides an electronic device. The electronic device comprises: a processing unit; and a memory coupled to the processing unit and having instructions stored thereon, the instructions, when executed by the processing unit, causing the device to perform acts of: determining a target depth map associated with a virtual viewpoint based on a set of images and a set of depth maps corresponding to the set of images, the set of images being captured by a set of image devices associated with a set of image capture viewpoints; determining depth difference information or angle difference information associated with the set of image capture viewpoints; wherein the depth difference information indicates a difference between depths of pixels in projected depth maps corresponding to respective image capture viewpoints and depths of corresponding pixels in a target depth map, the projected depth map being determined by projecting the target depth map to the corresponding image capture viewpoint, and the angle difference information indicates a difference between a first angle associated with the corresponding image capture viewpoint and a second angle associated with the virtual viewpoint, the first angle is determined based on a surface point corresponding to a pixel in the target depth map and a corresponding image capture viewpoint, and the second angle is determined based on the surface point and the virtual viewpoint; determining a set of blending weights associated with the set of image capture viewpoints based on the depth difference information or the angle difference information; blending a set of projected images based on the set of blending weights, to determine a target view corresponding to the virtual viewpoint, the set of projected images being generated by projecting the set of images to the virtual viewpoint.

In some implementations, determining a target depth map associated with the virtual viewpoint includes: down-sampling the set of images and the set of depth maps; and determining the target depth map corresponding to the viewpoint information, by using the down-sampled set of images and the down-sampled set of depth maps.

In some implementations, blending the set of projected images based on the set of blending weights includes: up-sampling the set of blending weights to determine weight information; and blending the set of projected images based on the weight information, to determine the target view corresponding to the virtual viewpoint.

In some implementations, determining the target depth map associated with the virtual viewpoint includes: determining an initial depth map corresponding to the virtual viewpoint based on the set of depth maps; constructing a set of candidate depth maps based on the initial depth map; determining probability information associated with the set of candidate depth maps by using the set of candidate depth maps to warp the set of images to the virtual viewpoint; and determining the target depth map in accordance with the set of candidate depth maps based on the probability information.

In some implementations, blending the set of projected images based on the set of blending weights includes: blending the set of projected images based on the set of blending weights, to determine a blended image; and the method further includes: using a neural network to perform post-processing on the blended image to determine a target view.

In a sixth aspect, the subject matter described herein provides a computer program product that is tangibly stored on a non-transitory computer storage medium and includes machine-executable instructions, the machine-executable instructions, when being executed by a device, cause the device to perform the following actions: determining a target depth map associated with a virtual viewpoint based on a set of images and a set of depth maps corresponding to the set of images, the set of images being captured by a set of image devices associated with a set of image capture viewpoints; determining depth difference information or angle difference information associated with the set of image capture viewpoints; wherein the depth difference information indicates a difference between depths of pixels in projected depth maps corresponding to respective image capture viewpoints and depths of corresponding pixels in a target depth map, the projected depth map being determined by projecting the target depth map to the corresponding image capture viewpoint, and the angle difference information indicates a difference between a first angle associated with the corresponding image capture viewpoint and a second angle associated with the virtual viewpoint, the first angle is determined based on a surface point corresponding to a pixel in the target depth map and a corresponding image capture viewpoint, and the second angle is determined based on the surface point and the virtual viewpoint; determining a set of blending weights associated with the set of image capture viewpoints based on the depth difference information or the angle difference information; blending a set of projected images based on the set of blending weights, to determine a target view corresponding to the virtual viewpoint, the set of projected images being generated by projecting the set of images to the virtual viewpoint.

In some implementations, determining a target depth map associated with the virtual viewpoint includes: down-sampling the set of images and the set of depth maps; and determining the target depth map corresponding to the viewpoint information, by using the down-sampled set of images and the down-sampled set of depth maps.

In some implementations, blending the set of projected images based on the set of blending weights includes: up-sampling the set of blending weights to determine weight information; and blending the set of projected images based on the weight information, to determine the target view corresponding to the virtual viewpoint.

In some implementations, determining the target depth map associated with the virtual viewpoint includes: determining an initial depth map corresponding to the virtual viewpoint based on the set of depth maps; constructing a set of candidate depth maps based on the initial depth map; determining probability information associated with the set of candidate depth maps by using the set of candidate depth maps to warp the set of images to the virtual viewpoint; and determining the target depth map in accordance with the set of candidate depth maps based on the probability information.

In some implementations, blending the set of projected images based on the set of blending weights includes: blending the set of projected images based on the set of blending weights, to determine a blended image; and the method further includes: using a neural network to perform post-processing on the blended image to determine a target view.

In a seventh aspect, the subject matter described herein provides a video conference system. The system includes: at least two conference units, each of which comprises: a set of image capture devices configured to capture images of participants of a video conference, the participants being in a physical conference space; and a display device disposed in the physical conference space and configured to provide the participants with immersive conference images, the immersive conference images including a view of at least one other participant of the video conference; wherein the at least two physical conference spaces of the at least two conference units are virtualized into at least two sub-virtual spaces which are organized into virtual conference spaces for the video conference in accordance with a layout indicated by a conference mode of the video conference.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A method for a video conference, comprising:
determining a conference mode for the video conference, the video conference including at least a first participant and a second participant, the conference mode indicating a layout of a virtual conference space for the video conference;
determining, based on the layout, viewpoint information associated with the second participant, the viewpoint information indicating a virtual viewpoint of the second participant viewing the first participant in the video conference;
determining a first view of the first participant based on the viewpoint information; and
sending the first view to a conference device associated with the second participant to display a conference image to the second participant, the conference image being generated based on the first view.

2. The method of claim 1, wherein the virtual conference space comprises a first sub-virtual space and a second sub-virtual space, the layout indicating a distribution of the first sub-virtual space and the second sub-virtual space in the virtual conference space, the first sub-virtual space being determined by virtualizing a first physical conference space where the first participant is located, the second sub-virtual space being determined by virtualizing a second physical conference space where the second participant is located.

3. The method of claim 2, wherein determining the viewpoint information associated with the second participant based on the layout comprises:
determining, based on the layout, a first coordinate transformation between the first physical conference space and the virtual conference space and a second coordinate transformation between the second physical conference space and the virtual conference space;
transforming, based on the first coordinate transformation and the second coordinate transformation, a first viewpoint position of the second participant in the second physical conference space into a second viewpoint position in the first physical conference space; and
determining the viewpoint information based on the second viewpoint position.

4. The method of claim 3, wherein the first viewpoint position is determined by detecting a facial feature point of the second participant.

5. The method of claim 1, wherein generating the first view of the first participant based on the viewpoint information comprises:
acquiring a set of images of the first participant captured by a set of image capture devices, the set of images corresponding to a set of depth maps;
determining a target depth map corresponding to the viewpoint information, based on the set of images and the set of depth maps; and
determining the first view of the first participant corresponding to the viewpoint information based on the target depth map and the set of images.

6. The method of claim 5, further comprising:
determining the set of image capture devices from a plurality of image capture devices for capturing a image of the first participant, based on a distance between the viewpoint position indicated by the viewpoint information and mounting positions of the plurality of image capture devices.

7. The method of claim 1, wherein determining the conference mode for the video conference comprises:
determining the conference mode based on at least one of: the number of participants included in the video conference, the number of conference devices associated with the video conference, or configuration information associated with the video conference.

8. A method for generating a view, comprising:
determining a target depth map associated with a virtual viewpoint based on a set of images and a set of depth maps corresponding to the set of images, the set of images being captured by a set of image devices associated with a set of image capture viewpoints;
determining depth difference information or angle difference information associated with the set of image capture viewpoints;
wherein the depth difference information indicates a difference between depths of pixels in projected depth maps corresponding to respective image capture viewpoints and depths of corresponding pixels in the target depth map, the projected depth map being determined by projecting the target depth map to the corresponding image capture viewpoint, and
the angle difference information indicates a difference between a first angle associated with the corresponding image capture viewpoint and a second angle associated with the virtual viewpoint, the first angle is determined based on a surface point corresponding to a pixel in the target depth map and a corresponding image capture viewpoint, and the second angle is determined based on the surface point and the virtual viewpoint;
determining a set of blending weights associated with the set of image capture viewpoints based on the depth difference information or the angle difference information; and
blending a set of projected images based on the set of blending weights, to determine a target view corresponding to the virtual viewpoint, the set of projected images being generated by projecting the set of images to the virtual viewpoint.

9. The method of claim 8, wherein determining a target depth map associated with the virtual viewpoint comprises:
down-sampling the set of images and the set of depth maps; and
determining the target depth map corresponding to the viewpoint information by using the down-sampled set of images and the down-sampled set of depth maps.

10. The method of claim 9, wherein blending the set of projected images based on the set of blending weights comprises:
up-sampling the set of blending weights to determine weight information; and
blending the set of projected images based on the weight information, to determine a target view corresponding to the virtual viewpoint.

11. The method of claim 8, wherein determining the target depth map associated with the virtual viewpoint comprises:
determining an initial depth map corresponding to the virtual viewpoint based on the set of depth maps;
constructing a set of candidate depth maps based on the initial depth map;
determining probability information associated with the set of candidate depth maps by using the set of candidate depth maps to warp the set of images to the virtual viewpoint; and
determining the target depth map in accordance with the set of candidate depth maps based on the probability information.

12. The method of claim 8, wherein blending the set of projected images based on the set of blending weights comprises: blending the set of projected images based on the set of blending weights, to determine a blended image; and
the method further comprises: using a neural network to perform post-processing on the blended image to determine the target view.

13. An electronic device, comprising:
a processing unit; and
a memory coupled to the processing unit and containing instructions stored thereon, the instructions, when executed by the processing unit, causing the electronic device to perform the method according to claim 1.

14. A computer program product that is tangibly stored on a computer storage medium and comprises machine-executable instructions, the machine-executable instructions, when being executed by a device, cause the device to perform the method according to claim 1.

15. A video conference system, comprising:
at least two conference units, each of which comprises:
a set of image capture devices configured to capture images of participants of a video conference, the participants being in a physical conference space; and
a display device disposed in the physical conference space and configured to provide the participants with immersive conference images, the immersive conference images including a view of at least one other participant of the video conference;
wherein the at least two physical conference spaces of the at least two conference units are virtualized into at least two sub-virtual spaces which are organized into virtual conference spaces for the video conference in accordance with a layout indicated by a conference mode of the video conference.
